(19) United States
(12) Patent Application Publication
(10) Pub. No.: US 2013/0238470 A1
(43) Pub. Date: Sep. 12, 2013

(54) SUBSTITUTING A USER-DEFINED WORD SET IN PLACE OF A FORMATTED NETWORK RESOURCE ADDRESS

(71) Applicant: Kellie M. Takahashi, Portland, OR (US)

(72) Inventor: Kellie M. Takahashi, Portland, OR (US)

(73) Assignee: Z:Wordz, LLC

(21) Appl. No.: 13/414,465

(22) Filed: Mar. 7, 2012

(51) Int. Cl. G06F 3/048; G06Q 30/00

(52) U.S. Cl. 705/27.2; 715/780

(57) ABSTRACT

A network resource address substitution system and method including stored machine-readable coded instructions. When executed, the instructions cause a computing device to present to a user one or more graphical user interfaces (GUIs). One such GUI includes data entry fields for a user to enter each of a network resource address such as a URL, one or more ordered keywords, and a user-selectable actuator which, when selected, creates a network-accessible link between the NRA and the keyword(s). A created link is stored at a data record as a link entry including each of the NRA and the keyword(s). The instructions are further configured to present to a user a GUI enabling a user to enter and submit keyword(s) to access a saved link, and to access the linked URL. Users can further reserve a link, and a data record will indicate that the link is reserved against subsequent changes.

### FIELD OF THE INVENTION

The invention relates generally to the field of accessing resources on a computer network. More particularly, the invention relates to simplified, user-designated addressing for existing internet-based resources.

### BACKGROUND OF THE INVENTION

The Internet is an example of a vast decentralized network of not only computing devices, but also of numerous smaller networks, allowing users to access resources located nearly anywhere on the Internet from nearly anywhere else on the Internet. Via the Internet, for example, a document stored on a server device in Portland, Oreg. is generally equally accessible to users in Portland, Oreg., or Portland, Me., or Istanbul, Turkey.

A key characteristic of the Internet—and of many other networks whether large or small, public or private—is the establishment and use of one or more relatively uniform schemes for identifying, locating, and accessing unique resources located on the network. An exemplar of such schema is the Uniform Resource Locator (URL) addressing format. Each URL includes at least some of: a scheme name, or protocol, followed by a colon and two slashes; a domain name or IP address (which may depend on the scheme); and the path of a resource, although a URL can include other components in some instances.

A well-known scheme name used on the Internet is the hypertext transfer protocol designated as http:. Other examples include https:, gopher:, ftp:, etc. A valid domain name corresponds to a typically numeric Internet Protocol (IP) address, and indicates an initial location of a resource on the Internet. For example, the domain name www.uspto.gov is unique and corresponds to the web site of the United States Patent and Trademark Office (USPTO), which is a branch of the United States government.

As will be readily recognized by an ordinarily skilled artisan, URLs can additionally indicate numerous sub-levels of organization, typically indicating or arranged in a hierarchical structure, leading eventually to the level at which a specific resource is located. A URL specifying the location of a specific file, for example, can include the name or another specific designation for the file, or instead a location that is unique to that file. For example, the URL http://www.uspto.gov/web/offices/pac/mpep/documents/mpep_smi_a.htm designates the location of the section of the index of the USPTO Manual of Patent Examining Procedure for terms beginning with the letter A.

URLs, and other forms of network resource addresses, suffer from several characteristics that hinder network users who may want to request from or provide to another user, information as to the location of a network resource. For example, URLs indicating a location of network resource can be extremely long and non-intuitive. Users frequently cannot remember the long strings of characters and identifiers that make up a URL, or simply may not wish to take the time required to recite, type, or write out an entire URL string.

Also, inadvertently omitting or changing even a single character in a URL, whether alphanumeric or symbolic (e.g., dashes, dots, slashes, underlined spaced, and others), will prevent the URL from functioning properly to indicate the correct location of the intended resource. Because a URL is not in the form of a word, any errors in the URL will usually remain undetected and uncorrected by spell-checking utilities of an internet browser program, for example. Further, the content of a URL frequently does not clearly or intuitively suggest the particular nature or title of the network resource to which it refers. Such abstractness frustrates memorization efforts.

Most commonly used Internet browser programs include the ability to save web sites as “bookmarks” or “favorites” (collectively bookmarks herein) so that a user can simply select a saved bookmark and navigate to an Internet resource rather than manually entering the entire URL into a search field of the browser. However, such bookmarks, etc. are particular not only to the individual Internet-accessible device on which they are stored, but also to the particular browser software on which they are saved. Therefore, bookmarks saved on a particular device are not typically accessible to the user at any other Internet-accessible device the user may use during the normal course of their day (e.g., home computer, mobile device, work computer, school computer, etc.), unless also separately saved on those other devices.

Preferred bookmarks must be individually saved by the user on each device, requiring the user to first navigate to the resource using the browser of each device, requiring repetitive and time consuming actions by the user. Further, if the user's system fails, or they change to a different browser, or suffer various types of software malfunctions, the user can either inadvertently lose their saved bookmarks or some portion thereof, or the file in which the bookmarks are saved on the system can become corrupted and non-functional. Additionally, once saved, the user cannot typically or easily transfer the bookmark itself to another user via voice, in writing, via e-mail, or otherwise.

Search engine software and programs, such as the widely used GOOGLE search engine, are convenient for performing broad internet searches for content based on one or more content-descriptive words submitted by a user at an entry field of the search engine. The search engine then searches for network resources in which those words appear. However, the entered words are not linked to any particular network resource, and any particular combination of words entered by a user can result in literally tens of thousands of “hits,” or network resources containing one or more of the user-designated search terms. Such search breadth is useful for performing research, but does not enable a user to navigate directly to a particular target network resource. In fact, while a particular combination of words can return a search result of thousands of network resources, any particular network resource may likewise be returned by multitudes of searches each utilizing different terms or combinations of terms, because the terms are not specifically linked to a particular network resource within the context and manner of this specification.

Additionally, not only do different search engines rank sites differently, but lately, in an attempt to personalize the search retrieval experience, some search engines present different search results to different users, based on factors such as geographical location and information stored on a browser cookie that associates the user with a history of links that he/she has clicked on in the past. One purpose of such approach is to capitalize on a higher click-through rate the search engine present to the user links that are similar to what the user has expressed an interest in the past.

Several services and resources exist on the Internet that allow a user to designate and substitute a shortened URL for a longer URL. For example, the web-site tinyurl.com (found at http://tinyurl.com) allows users to paste or type a long URL into a text entry field, and the system will create a short alias URL. Alternatively, the user can enter into another text entry field a custom (user-specified) text string to append to the pre-existing root http://tinyurl.com/. The system then creates an alias URL using the root and the custom URL (e.g., http://tinyurl.com/usptompep). In either case, the resulting short URL contains the root http://tinyurl.com/. This routes any request for the URL first through the tinyurl.com servers, where the shortened URL is resolved for the longer URL that it represents. Navigation then continues to the intended network resource.

However, the user must still correctly remember and enter into a browser, or convey to others verbally or in writing, a complete and properly formatted URL string, albeit shortened. When using a mobile device, such as an Internet capable smart phone device, the user must frequently switch back and forth between a text entry screen and a symbol entry screen while entering the URL into a search field, requiring numerous key strokes and increasing the opportunity for error. Additionally, although short, a system-generated alias URL may still bear no intuitive relationship to the intended resource, frustrating memorization methods, particularly when a user wishes to remember the addresses to numerous network resources. Therefore, a user is nearly forced to maintain and carry with them a recorded list of the shortened URLs corresponding to each of the numerous long URLs they may have recorded via the service, particularly if they wish to access those shortened URLs from multiple network-linked devices.

Therefore, at the current state of the art, users are presented with multiple difficulties and inconveniences when re-navigating to a previously accessed network resource, when instructing others how to access a particular network resource, or when receiving such instruction from others.

### BRIEF DESCRIPTION OF THE DRAWINGS

FIG. 1 depicts an exemplary computing network, within which the invention may reside and operate according to an embodiment of the invention.

FIG. 2 depicts a link creation graphical user interface (GUI), according to an embodiment of the invention.

FIG. 3 depicts the link creation GUI of FIG. 2 with user-specified data entered at data entry fields thereof, according to an embodiment of the invention.

FIG. 4 depicts a link retrieval GUI, according to an embodiment of the invention.

FIG. 5 depicts a GUI indicating an already-existing link, according to an embodiment of the invention.

FIGS. 6-8 each depict process flow diagrams including link creation operations according to alternative embodiments of the invention.

### DETAILED DESCRIPTION OF THE PREFERRED EMBODIMENTS

Embodiments of the invention described herein simplify the process of accessing network resources, such as web pages, documents, multimedia, etc. Stated succinctly for convenience only, the invented embodiments enable a user, by use of a suitably configured graphical user interface (GUI) and associated coded instructions, to link a user-specified word or combination of words to a specific address for a network resource—for example a URL. The link, including the URL, is stored (recorded) in a data record at a network-accessible data storage device. Navigation to the network resource is then achieved by entering the linked user-specified words into a field of a suitably configured GUI. The linked URL is determined by locating the stored link in the data record. The user or another user can then navigate directly to the targeted resource.

In alternative exemplary embodiments, operable coded instructions of the invented embodiments are stored at a centralized resource or location on a network. The coded instructions, or a user interface for accessing the same, can be administered by a service provider, such as a commercial entity, a network administrator, an institution, a charitable organization, or another entity. The operable coded instructions can be stored, maintained, upgraded, access-limited, executed, served up to users, or otherwise controlled or affected by such service provider to the benefit of users or of the controlling entity, as the case may be in an embodiment. The controlling entity will typically provide to users a means to access the operable instructions, for example at a web page designated by a URL or other network resource address, and operable user interfaces (e.g., of the web page) of the invented embodiments are served up to users that access the instructions.

The invention is described herein by the use of several exemplary, non-exclusive embodiments. Occasionally, ordinary terms in the art may fail to adequately or specifically describe aspects of the embodiments, or may present the possibility of improper interpretation of applicant's conceived embodiments. Therefore, special definitions may appear throughout this description. Where terms used herein are subject to multiple meanings, or are used in an other than ordinary manner, whether the term itself is novel or ordinary, they are to be interpreted first according to special definitions provided herein. If no special definition for a particular term is provided herein, only those ordinary meanings which comport firstly with the explicit description, drawing figures, claims, and with what one having ordinary skill in the art would understand from the same, shall be considered proper. To assist the reader's recognition of the scope and nature of the described embodiments, several terms used throughout this specification are defined below.

### DEFINITIONS

“Network resource address,” or “NRA” herein, most typically includes, but is not limited to, a uniform resource locator (URLs) or a uniform resource identifier (URI). More generally, a network resource address is any formatted string of characters, words, symbols, or punctuation configured, when resolved during network navigation, indicates the location (e.g., internet protocol (IP) address, etc.) of a particular network resource accessible on or via the network. Typically, an NRA indicates the location of a specific network resource, but an NRA remains such whether or not the target network resource is actually present and operable at the indicated location (e.g., the resource has been deleted, corrupted, is access-protected, etc.).

“Network resource” herein refers generally to any specifically identifiable data, in any form, that may be accessed via a network. Typically, although not exclusively, a network resource is in the form of data stored at a location on the network—or accessible via a network—corresponding to a specific NRA. For example, a network resource can be a document file, a multimedia file, a web page, or any other type or form of data accessible via an NRA, as would be recognized by an ordinarily skilled artisan. For convenience only, this description occasionally refers to a network resource as a “page.”

“Data record” refers to an identified and structured set of data having distinct characteristics relating to a designated purpose within the invented embodiments. The data record is stored at a non-transitory data storage medium, and can be part of a network database. In a typical embodiment described herein, a data record is configured as a data table having defined columns and rows, and data entry fields each referenced to a particular column and row combination. As used in the description that follows, the phrase “data record” typically refers to a ‘link data record,’ which lists and retains user-created links between network resource addresses (e.g., URLs) and one or more user-designated keywords.

“Non-transitory data storage medium” refers generally to any durable medium known in the art upon which data can be stored and later retrieved by data processing circuitry operably coupled with the medium. A non-exclusive list of exemplary non-transitory data storage media includes magnetic data storage media (e.g., hard disc, data tape, etc.), solid state semiconductor data storage media (e.g., SDRAM, flash memory, ROM, etc.), and optical data storage media (e.g., compact optical disc, DVD, etc.).

“Graphic user interface,” abbreviated “GUI,” generally means a visual representation of programs, files, or options presented to a user—via graphical images, such as icons, menus, or dialog boxes—at a display device operably coupled with data processing circuitry. The general concept of graphic user interfaces is well-known in the relevant art; however, an ordinarily skilled artisan will readily recognize that entirely novel and non-obvious inventions arise almost daily that utilize a GUI for user interaction. Therefore, the use or inclusion of a GUI itself does not at all detract from the novelty and non-obviousness of the invented embodiments described herein. Indeed, the several GUIs described herein each correspond to specifically configured coded instructions, the novel arrangement and configuration of which enable the function of and benefits derived from the invented embodiments.

“Entry field” herein generally refers to a text entry field of a GUI, enabling a user to enter text (e.g., alphanumeric characters, symbols, punctuation, etc.) via an input device, for further processing by the data processing circuitry and invented coded instructions. An entry field may, in an embodiment, be configured to limit the number of characters, or the number of separate strings of characters, that may be entered therein. For example, an entry field may be configured, according to an embodiment, to only allow entry of a single word.

“Predetermined” generally means determined in advance—e.g., prior to the occurrence of a particular event or the execution of a particular operation or process—as in the case of a variable or other parameter determined in advance by a user, a system administrator, or another. In an embodiment, predetermined means that a particular variable or other parameter is coded into the instructions upon creation of such instructions, and is not later changeable by a user, although alternative embodiments enable a user or another to alter a predetermined “default” setting prior to an event. Typically, a predetermined parameter is encoded and stored as data at a data storage medium. The embodiments also contemplate that a predetermined parameter may be defined, selected, recorded, designated, or otherwise determined by a non-human system in response to the execution of coded instructions by suitable data processing circuitry.

“Ordered” generally means sequential, or having a defined order. Alternatively, herein, ordered can mean that two or more items have a predetermined and designated (assigned) order or sequence, although in other respects, those items may not necessarily be presented (e.g. as visually presented in a GUI) in an order that corresponds to the assigned order. For example, a designated “first” data entry field may be visually presented to a user after a designated “second” data entry field. One such example wherein a presented order varies from a typical or designated arrangement is frequently seen in web-based registration forms, where a user is asked to enter his last name first, and his first name last. A predetermined ordering of entry fields, for example, may be designated in coded instructions, and may not be apparent to a user in all cases.

“Network” is intended to carry its plain meaning. For example, the Microsoft Computer Dictionary Fourth Edition (1999) defines a network as:
A group of computers and associated devices that are connected by communications facilities. A network can involve permanent connections, such as cables, or temporary connections made through telephone or other communication links. A network can be as small as a LAN (local area network) consisting of a few computers, printers, and other devices or it can consist of many small and large computers distributed over a vast geographic area (WAN or WIDE AREA NETWORK).

Because many electronic devices now possess data processing circuitry and capabilities, including mobile phones, game-playing devices, navigation devices, multimedia players, and others, the term computer (or computing device) as used in the excerpt above is interpreted broadly herein, and with respect to the described embodiments, to include all such devices that are connectable to and operable across a network. The Internet is an exemplary network herein, although the contemplated embodiments are broad and include both public and private networks, whether institutional, corporate, governmental, proprietary, or otherwise affiliated.

“Instructions . . . executed” generally means that coded instructions are executed on or by a device possessing operable data processing circuitry. Examples of such devices include a computing device (e.g., desktop, notebook, tablet, palmtop, etc.), a communications device having data processing capabilities (e.g., “smart” phone), a network computing device (e.g., server), a gaming device (e.g., NINTENDO Wii, SONY PLAYSTATION, etc.), multimedia players (e.g., television, DVD player, portable music player, etc.), or other devices having data processing circuitry or capabilities.

### DESCRIPTIONS OF EXEMPLARY EMBODIMENTS

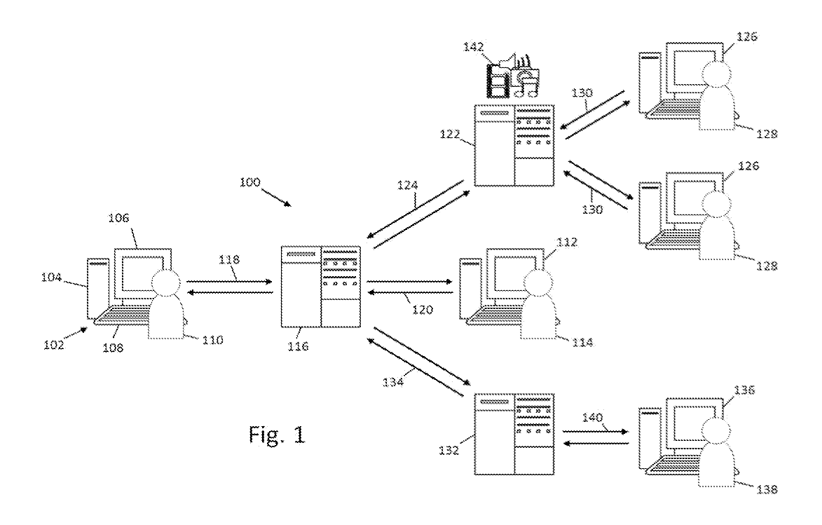

Turning now to the figures, embodiments of the invention are configured to operate within a network, such as the exemplary network 100 shown in simplified form in FIG. 1. Such network may be large or small, public or private, widely distributed or relatively localized. A brief description of an exemplary network is provided herein to aid in describing the configuration and function of the invention according to one or more embodiments.

A network typically includes one or more computing devices 102/112, each controlled by or accessible to at least one user; 110 and 114, respectively. A computing device can be stationary, (e.g., a desktop computer), or mobile (e.g., a notebook computer, a network-enabled cellular ‘smartphone,’ etc.). The contemplated embodiments are broad, however, and encompass configuration for use within virtually any data processing device capable of transferring data within a network.

An exemplary computing device typically includes a data processing portion 104, an operably coupled display device 106, and an operably coupled input/output (I/O) device 108. Either of an operably coupled display device 106 or an I/O device 108 can be integrated into a single housing with the computing device in an embodiment, such as in a notebook or tablet computer, a mobile phone, etc. The data processing portion typically includes data processing circuitry, such as may be embodied in an integrated circuit chip or similar device, and can also include or be operably coupled with a data storage portion configured with non-transitory data storage. However, the embodiments also contemplate the use of removable data storage media or devices that can be operably coupled with a computing device during use, yet can be decoupled from the computing device when not in use, or for use with another computing device. The display device 106 can take any of the numerous forms as would be known to an ordinarily skilled artisan, including a display screen integrally incorporated into the body of the computing device, or a separate display device operably coupled with the computing device by a cord or by a wireless connection.

In a network, the computing device 102 of a first user 110 may typically be linked to the computing device 112 of a second user 114 by a server device 116, enabling communication and data exchange therebetween. The server device 116 can be nearly any device configurable to operate as a server within a network as would be recognized by an ordinarily skilled artisan, whether specifically designed and configured as a server device, or a general use computer configured to function as a server device within a particular network.

The server device 116 likewise typically includes a data processing portion, a data storage portion (either integrally formed with or operably coupled with the server device), and a data transfer portion, the latter configured for each of receiving data and transmitting data. The particular arrangement and configuration of these portions within a server device is well-known to an ordinarily skilled artisan, and is not critical to obtain an understanding of the invented embodiments, so is neither described in detail here nor depicted in FIG. 1.

In a typical embodiment, the invented system resides as machine-readable, coded instructions stored at a data storage portion of the server, accessible to and executable by the data processing portion of the server. For example, a user can access the coded instructions by navigating to an interne web page, and the coded instructions will present to the user an operable GUI of the invention according to one or more of the described embodiments. The GUI also is configured to provide user access to operable features of the instructions that correspond to and can be executed by user interaction with visible portions of the GUI. Various features and the corresponding structure of the coded instructions are presented in further detail throughout this description.

The respective connections between the first user device 110 and the server device 116, at 118, or between the server device 116 and the second user 114, at 120, can be via any wired or wireless connection, or combination of both, including but not limited to telephonic, WiFi, WAN, LAN, satellite-enabled, fiber optic, cable, etc. Such connections typically enable bi-directional data transmission, as is indicated in FIG. 1 by the bidirectional arrows. The particular type of each connection means is not limited within the claimed invention, and can include any operable network connection type currently known to an ordinarily skilled artisan. This is likewise true for the several other connections between devices in the exemplary network, as shown in FIG. 1 at 124, 130, 134 and 140. It will be understood by an ordinarily skilled artisan in light of this description that a user's computing device, and therefore also a user's display device, can be considered to be operably-coupled with the server device via such network connections, enabling transfer of signals (e.g., data, communications, instructions, etc.) therebetween.

User devices 102 and 112, and server 116, each have an assigned address on the network, typically but not exclusively an internet protocol (IP) address, according to either of IP Version 4 or IP Version 6, for example. Devices may be alternatively identified by a phone number, a user account number, or any other such specific designation. The IP address functions to provide each of host or network interface identification, and location addressing, so that each device in the network can be both identified and located for communication and data exchange across the network. Each IP address can likewise be designated by a network address, such as a URL, which uniquely identifies the location of the device in the network. Not all network addresses are URLs; however, for descriptive convenience herein, a URL is used as an exemplar representing any type of currently known network addressing.

A network can also include one or more other servers, as shown at 122 and 132, providing connections to and between other users 128/138, or more correctly, to those user's respective computing devices 126/136. Each server device and user device in the network is likewise designated by a unique IP address, and typically also a URL, enabling a user to direct communications or data transfer with a particular ‘target’ device, even though the user's device may be widely separated from the target device, either geographically or by numerous network nodes. In particular, any network resource, or “page,” such as multimedia files 142 stored at any device on the network, can be likewise identified, located, and accessed across the network by a network resource address, such as a URL, assigned or otherwise designated for the page.

### Creating a URL/Keyword Link

A first user 110, having knowledge of the URL for a page 142, may wish to provide to a second user 114 information sufficient to enable the second user to access the page. However, depending on the location of the page on the network, characteristics of the page, or the location of the page within an organizational hierarchy of the server 122 at which the page is stored, the URL for the page could be quite long and complex. In such cases, the URL is not easily memorized, recited, written, or otherwise conveyed from the first user to the second user.

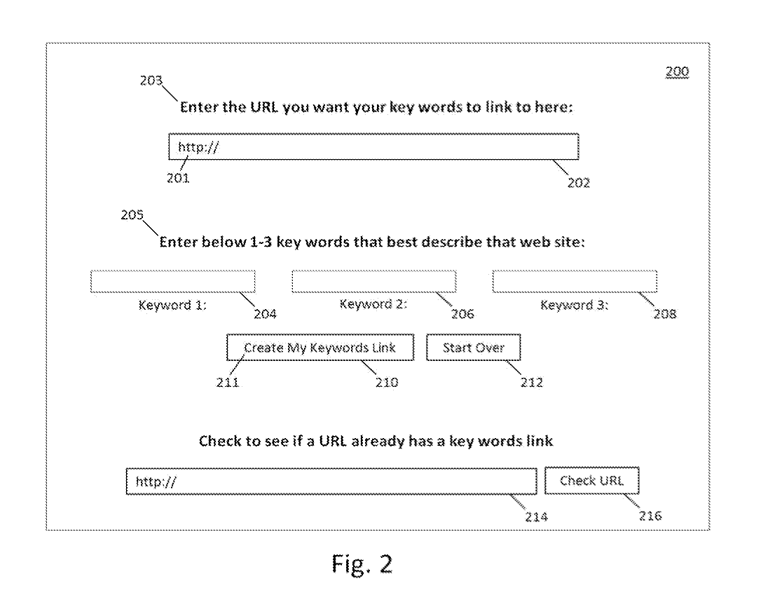

As shown in FIG. 2, an embodiment of the invention includes machine-readable coded instructions configured, when executed by a network-linked computing device, to cause the computing device to render a GUI 200 viewable to a user. For descriptive convenience herein, the depicted GUI is referred to herein as a link creation GUI 200. The link creation GUI provides an uncluttered means for a user to specify a URL, specify one or more keywords to be linked to the URL, and to cause a link between the URL and the keywords to be created and stored for later use. An exemplary pseudocode representation of coded instructions configured to create a typical embodiment of the link creation GUI can include:

Create form

Create text field for first keyword
Create text field for second keyword
Create text field for third keyword
Create text field for URL
Create submit button, when clicked to go to Link Creation
Confirmation page

End form

The GUI 200 includes a data entry field 202, typically a text entry field, referred to herein as a network resource address entry field, or URL entry field. The URL entry field 202 is configured to receive input by a user via an input/output (I/O) device, such as a keyboard, a mouse, a voice-to-text application, device or program, a haptic interface, an eye-motion recognition system, or any other I/O device, system, or program currently known in the art by which a user can cause text, symbols, or other characters to be entered at a GUI. The URL entry field 202 can also receive text via a cut-and-paste or copy-and-paste operation, enabling a user to copy a URL directly from an address field of a network browser program, from an e-mail or text message, from a document, or from nearly any other source displayed at a display operably coupled with a computing device.

Generally, the text entered at the URL entry field 202 will be a string of alphanumeric and symbolic characters representing an address of a network resource. In a typical case, the network resource indicated by the address will already exist and be accessible to users on the network. However, the embodiments also contemplate linking of a network address for a resource that either does not yet exist, or is not yet rendered accessible to one or more users on the network (e.g., may be password protected, sequestered, or otherwise access-limited). In such cases, the invented system can nevertheless typically create and store a record of the operable link, although navigating to the link may not successfully provide access to the resource, much as conventionally navigating to a ‘dead’ link—where the target file or other resource has been deleted, for example—currently will fail to provide access to the expected resource.

A data record in a typical but non-exclusive embodiment will comprise a table in a database, the table having plural columns. For example, an exemplary table named “Links” may be created by execution of instructions, pseudocode for which can be represented as:

Create a table named Links with columns named Keyword1, Keyword2,
Keyword3, URL, Date_Created, and Paid.

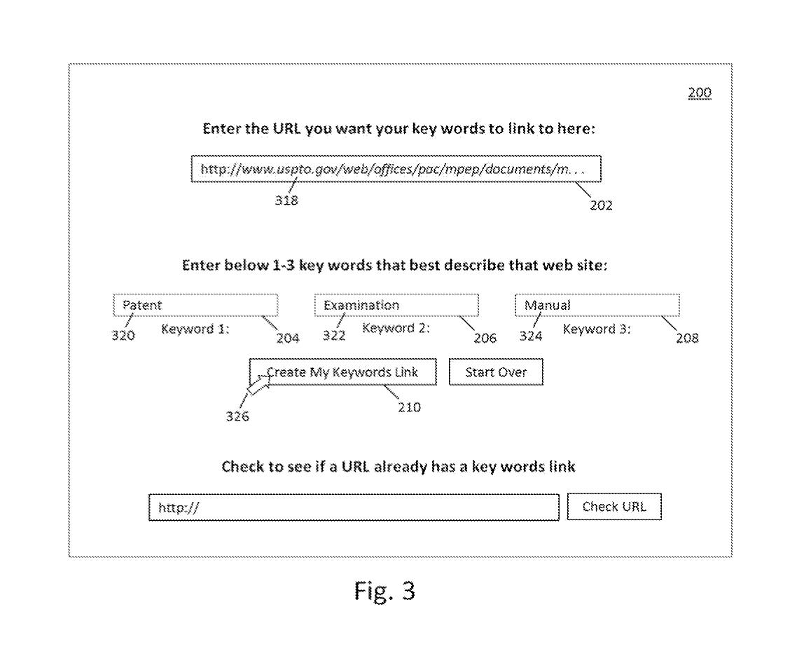

Although FIG. 3 depicts the URL entry field 202 in a typical position near the top of the GUI, such positioning is exemplary only, and does not restrict the GUI to such positioning. Likewise, the exemplary URL entry field 202 is depicted with the text “http://” 201 already present. While convenient for users, alternative embodiments do not include such pre-entered text, or in a proprietary network implementation wherein a scheme name other than http: is consistently utilized, such other scheme name can be pre-entered at the URL entry field as a convenience for users.

Associated with the URL entry field, instructional text 203 can also be provided to inform users regarding what should be entered into the URL field. The instructional text can simply be a title for the field—e.g., “URL Entry Field”—or can additionally include an example URL to help the user understand what should be entered at the URL entry field (e.g., http://www.uspto.gov/web/offices/pac/mpep/documents/mpep_smi_a.htm).

Coded instructions associated with the URL entry field are configured, in an embodiment, to recognize an entered character string as being a URL or another form of network address, or alternatively, to recognize that the entered URL is not an appropriate or functional form of a network address. In such situations, the coded instructions may be configured, in an embodiment, to indicate to the user that the entered character string includes errors, is not resolvable as entered, or otherwise requires correction.

The link creation GUI 200 further includes one or more data entry fields 204, 206, 208 likewise configured to receive text entry by the user, referred to herein as keyword entry fields. Each keyword entry field is configured, in a typical embodiment, to receive entry of a single word. More particularly, a user determines which word to enter into each of the fields, therefore designating the word or words to be linked to the indicated URL, and in an embodiment, a particular order of such words. The GUI 200 may also include instructional text 205, or some other form of prompt associated with the one or more keyword entry fields, indicating to the user what action is expected with regard to the keyword entry fields 204, 206, and 208.

As shown in FIG. 2, the one or more keyword entry fields may be arranged and labeled to indicate a particular order. A depicted order is merely to provide a clear and uncluttered GUI appearance in at least one embodiment, and the order has no particular effect in subsequent functions of the system to provide navigation to a particular network resource. However, in at least one embodiment, a particular order of two or more user-determined keywords entered at the ordered keyword entry fields thereafter becomes a fixed characteristic of a created link, and successful navigation to the specified and linked URL requires that a user specify the keywords in that same order. An ordinarily skilled artisan will readily recognize that restricting keywords to a particular order increases the number of links that can be established. For example, in an embodiment with two keywords, simply swapping the order of the words provides two separate word order combinations, and enables formation of two correspondingly unique links.

Whether or not the order of keywords entered at the ordered keyword entry fields becomes a fixed characteristic of a created link can be either of a predetermined aspect of the coded instructions, or can alternatively be a user-determined characteristic specified by the user via an option presented at the GUI 200 prior to creating the link. In the case of a user-specified option, the coded instruction may include an indication of a default condition (e.g., “fixed order”), and the GUI may present a user-selectable option enabling the user to indicate an intent to deviate from the default condition.

Although the contemplated embodiments include alternatives in which different numbers of key words may be linked to a URL, a preferred embodiment of GUI 200 presents three keyword entry fields to the user for entry of just three keywords, as shown in FIG. 2. This embodiment exemplifies the “Rule of Three,” which has been shown to optimize memory retention. Establishing links based upon three keywords provides a beneficial balance between selection variability and simplicity, facilitating achievement of the unique benefits provided by the invented system and method.

A typical embodiment contemplates that words entered at each of the one or more keyword entry fields 204, 206, and 208 will be plain text words of a single language. Therefore, unlike with a URL, a spelling checking program present on the user's computing device, or present and operable on a network within which the user is operating, can typically recognize potential errors in a user-entered keyword(s) and recommend corrections if a word is incorrectly spelled. However, alternative embodiments likewise contemplate high degrees of variability, permitting: mixed use of words from different languages; use of slang or user-invented words; use of alternative word spellings; use of combinations of alphabetic and numeric characters, use of proper names (e.g., of people, places, companies, institutions, products, etc.), and other such variations or combinations. Likewise, the contemplated embodiments include either of case sensitivity or case insensitivity, enabling either of enhanced user flexibility (via case insensitivity) or a vast increase in the number of possible keyword combinations (based on case sensitivity and numerous permutations of character capitalization within one or more of the user-specified keywords).

The link creation GUI typically also includes some form of user-selectable link actuator 210 configured, when selected by the user via an I/O device, to cause the creation of a link between the user-designated URL and the one or more user-designated keywords. The link actuator 210, in whatever form it may be presented to the user, is configured and functions according to coded instructions comprising a portion of a contemplated embodiment of the invention. As shown in FIG. 2, a link actuator 210 can also include associated textual instructions 211 indicating to a user a function that will be performed upon selection of the link actuator.

Typically, the link actuator 210 is presented at the GUI as an icon representing a ‘submit button’ which, when selected by a user, initiates execution of link creation instructions causing data processing circuitry to create and store a link between the selected URL and the one or more selected keywords. User-selectable button icons in a GUI will be familiar to an ordinarily skilled artisan. Alternatively, the link actuator may simply be presented as text that is similarly selectable and effective. When the user selects the link creation actuator, the coded instructions associated with the link creation GUI submits the user specified URL and keyword(s) to a PHP (PHP: Hypertext Preprocessor) page, for example, that updates the data record accordingly. According to an exemplary embodiment, a created and stored link is indicated in the data record by associating the URL and keywords in a common row of the “Links” table.

Optionally, as shown in FIG. 2, an embodiment of a link creation GUI 200 can also include a data entry field 214 at which the user can enter a URL or other NRA, and a control icon 216 and associated coded instructions configured, when selected by a user and executed by data processing circuitry, respectively, to initiate a search of a data record for any stored links that include that same URL. In an exemplary embodiment, the data record is part of, or is retained within, a MySQL database.

If a stored link is found in the data record, the system returns an indication to the user that a stored link exists. The indication may be one or more of visible indicia produced at the GUI, or audio indicia emitted by a suitable speaker, transducer, or other audio component of the computing device, or user-detectable haptic indicia produced at a haptic device, or another user-detectable indication.

In a typical embodiment, a similar search of already-stored links will be performed by the system upon selection of the link actuator 210 by the user. If a stored link for the URL indicated in the URL entry field 202 is found in an associated data record, one of several actions may occur depending upon various then-present conditions, and depending upon the configuration of the coded instructions in a particular embodiment of the invention:
1. The system may overwrite the existing link for that URL with a newly-created link based upon the newly-specified one or more keywords.
2. The system may check a data record to determine whether the stored link entry for the URL includes an indication that the link cannot be changed.
3. The system may check a data record to determine whether, although an already-existing link to the URL includes an indication that it cannot be changed, a condition is satisfied allowing that indication to be ignored. Such condition can be, for example, the expiration of a predetermined period of time since the original creation of the link, or of a predetermined period of time corresponding to a payment submitted by a creator or other sponsor of the link.

In either of the events that the system determines an already stored link exists for the indicated URL, or that the already stored link cannot be changed, the system can prompt the user in one of or a combination of the following ways:
1. The system may notify the user that a stored link already exists for that URL, and that the system will not store the requested link.
2. The system may produce an error message.
3. The system may display or otherwise inform the user of the keywords already linked to the URL, so that the user can use the already-existing link.
4. The system may query whether the user wishes to submit a payment to replace the existing link with the requested link.
5. The system may query whether the user still wishes to create the requested link, and if answered affirmatively, the system may create and store the requested link despite the continued retention of the already-existing link for the same URL.

Additionally, or alternatively, the search described above is performed, in one or more embodiments, except that the system checks to see whether the same keyword or combination of keywords already exists in a stored link, and the system can likewise take any one of or a combination of the actions listed above, but with respect to the designated keywords rather than the designated URL. Likewise, the system may determine that the same combination of keywords exist in an already stored link, but that the order of the designated keywords, or a combination of upper-lower case variations, or some other distinguishing characteristic, is unique relative to any already existing and stored link.

Pseudocode of exemplary instructions for performing some of the above actions may be represented as:

Connect to database
Check to see if that keyword combination has already been used
If the combination has not been used

Insert keywords, URL, date created, and payment status into table

If a user submits a link request by selecting the link actuator, but the user has omitted a URL at the URL entry field, or omitted a keyword (or failed to enter a number of keywords specified in an embodiment), the instructions are configured to recognize the deficiency, and to notify the user regarding the error. Such instructions can be represented in an embodiment by the following exemplary pseudocode:

If no URL submitted

Print error message
End code

If no words submitted:

Print error message
End code

For exemplary purposes only, FIG. 3 depicts the link creation GUI of FIG. 2, but with a URL 318 entered in the URL entry field 202 by a user. As shown, a character string of a URL 318 may be too long to visibly fit within the provided URL entry field, although the entire URL http://www.uspto.gov/web/offices/pac/mpep/documets/mpep_smi_a.htm is entered at the entry field 202.

Also shown in FIG. 3 are three keywords 320, 322, 324 entered by a user into the three ordered keyword entry fields 204, 206, and 208. The user's cursor 326 is shown positioned for selecting the link creation actuator 210 by, for example, pressing a button of a mouse, pressing the “Enter” key of a keyboard, or by another method as may be known in the art.

Although a created link remains unchangeable for a predetermined period of time following creation in a typical embodiment, at least one alternative embodiment enables a user to correct mistakes or otherwise change a link after it has been submitted. For example, a user may enter a URL and one or more designated keywords, and select the link actuator to create the requested link. Although the link is created and saved at the data record, the system provides a predetermined period of time—e.g., one minute—within which the user can submit a new link creation request including the same keyword or keyword combination, but specifying a corrected URL or a different URL entirely. In an embodiment, upon selecting the link actuator to submit the link creation request, the link creation GUI presents to the user a message indicating a period of time within which the requested link can be corrected/changed, and further may also indicate to the user instructions regarding how to correct/change the submitted link.

In response to the subsequent link creation request, the system searches the data record for a saved link having the same keyword or keyword combination. If a link with matching keywords is located, the system then compares a current time and date to stored information indicating the time and date at which the existing link was created. If the difference between the two times is less than or equal to the predetermined period of time for making changes to a link, the system deletes the existing link and instead creates and stores a link corresponding to the subsequently submit URL and keyword(s).

If, however, the difference in times between the creation of the existing link and the subsequently submitted link request is greater than the predetermined period of time for making changes to a link, the system will retain the existing link, and typically but not exclusively, will also notify the user that the requested link cannot be created. An ordinarily skilled artisan will readily recognize that the predetermined time for making changes can be set to be any duration, including zero (i.e., no ‘grace period’ for changes), in an embodiment. Likewise, the grace period for changes can also be variable in an embodiment, enabling a longer duration in some situations than in others, as may be determined by a system administrator or by a preprogrammed system response upon the satisfaction of a predetermined condition (e.g., payment of a fee).

### Using Linked Keywords to Access a Network Resource

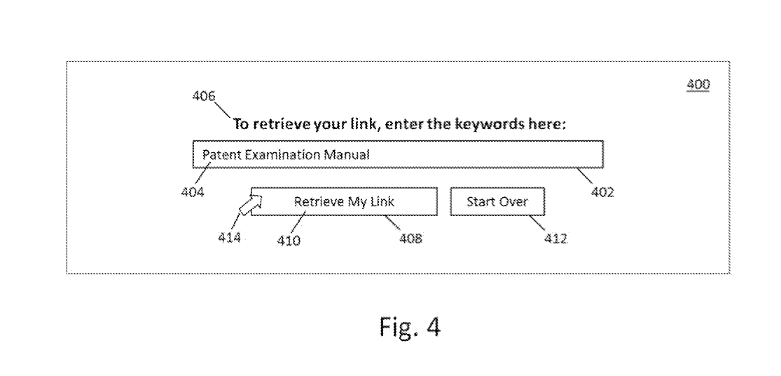

FIG. 4 depicts an embodiment of a GUI 400 presented to a user by the invented system, to enable the user to access a network resource by use of keywords linked to the URL of the network resource. For descriptive convenience, the GUI 400 depicted in FIG. 4 is referred to herein as a link retrieval GUI.

As shown, a typical embodiment of a link retrieval GUI 400 includes a data entry field 402—referred to herein as a link retrieval entry field for convenience only—configured to receive entry by a user of one or more keywords 404. Generally, the user will enter keywords, known or believed to be linked to a URL of a target network resource, and for which the link is stored in a corresponding data record. Likewise, the user will typically enter the keywords 404 in an order believed to correspond to the order designated at the time the link was created, although as mentioned, the specific order of the keywords is not critical to enabling link retrieval in all embodiments.

As depicted in FIG. 4, the link retrieval entry field can be unitary, such that the user enters all keywords for a link into the one link retrieval field. However, an alternative embodiment, plural link retrieval entry fields are presented to the user, and the user enters into each such field one word of the one or more keywords the user believes to be linked with a URL of a target resource.

The link retrieval GUI 400 may also include instructional text 406, or some other form of prompt associated with the link retrieval entry field 402, indicating to the user what action is expected with regard to the link retrieval field.

The link retrieval GUI further typically includes some form of user-selectable link retrieval actuator 408 configured, when selected by the user via an I/O device, to initiate execution of coded instructions configured to cause data processing circuitry to access and search a stored data record for a stored link containing the same keywords as those entered at the link retrieval entry field by the user. As shown, a link retrieval actuator 408 can also include associated textual instructions 410 indicating to a user a function that will be performed upon selection of the link actuator.

For example, FIG. 4 depicts an example instance in which the user has entered in the link retrieval entry field 402 the keywords “Patent Examination Manual” 404 corresponding to the keywords 320, 322, and 324 of a link created by a user according to the exemplary link creation action depicted in FIG. 3. Selection of the link retrieval actuator 408, as indicated in FIG. 4 by the positioning of a user's cursor 414 over a portion of the link retrieval actuator and pressing a button of a mouse, pressing the “Enter” key of a keyboard, or by another method as may be known in the art, causes the system to search for a stored link corresponding to the user-entered keywords “Patent Examination Manual” 404.

An embodiment of coded instructions configured, when accessed and executed by data processing circuitry, to present a link retrieval GUI to a user can be represented by the following exemplary pseudocode:

Create form

Create a text field for the search terms
Create submit button, when clicked go to Link Search Result page

End form

Upon selecting the link retrieval actuator ‘button’ and ‘submitting’ the link retrieval request, the data processing circuitry, again via execution of suitably configured coded instructions, examines the data submitted by the user to ensure that sufficient data has been provided. If the user has failed to provide any text in the link retrieval entry field 402, the system indicates the error to the user. Exemplary pseudocode for such action may be represented as:

If the text field was blank when submitted

Print error message
End code

Provided the system determines that the user has entered text into the link retrieval entry field, the system then, in an embodiment, analyzes the character string of the text in the link retrieval entry field. Based upon the presence of spaces inserted within the character string, or of some other indicator of word separation, the system identifies thusly separated portions of the character string as separate keywords, and searches the data record for a link that includes those keywords. Exemplary pseudocode for these actions may be represented as:

Split the result from the form into the individual keywords
Connect to database
Search table for the URL that those keywords are linked to

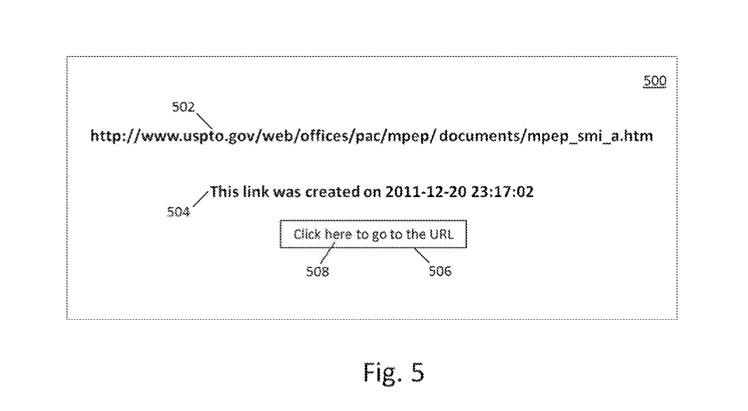

If the search of the data record indicates that a stored link corresponding to the specified keywords exists, the system causes an indication of such to be presented to the user. In the exemplary embodiment in FIG. 5, the indication includes displaying the located and linked URL 502 to the user via a GUI 500. The date that the link was created may also be presented to the user, as shown at 504. Additionally, the system also includes coded instructions configured, when executed, to present to the user a control icon or other indication—referred to herein as a user-selectable navigation actuator—and configured, when the navigation actuator is selected by the user, to access the linked and indicated URL. Exemplary pseudocode for these actions may be represented as:

If a URL is found:

Print URL
Print the date created
Print button, when clicked go to URL

Accessing the URL, according to a typical embodiment, includes causing an internet browser application operating on the user's computing device to navigate to an IP address or other network location corresponding to the URL. However, in light of this description, an ordinarily skilled artisan will recognize that in alternative embodiments, such as a proprietary network that utilizes NRA schemes other than URLs, or network access applications other than an internet browser application, alternative embodiments of the invention likewise are configured to navigate to network resources using such alternative network access applications and NRA schemes.

If the search fails to locate any stored link corresponding to the specified keywords, the system likewise causes an indication of such result to be presented to the user. The indication can take the form of an error message. Exemplary pseudocode for the actions under this circumstance may be represented as:

If no URL is found:

Print error message
End code

### Payment-Based Control of Link Creation and Retention

Embodiments of the invented system provide a user with several payment-based options relating to link creation. Depending upon an option selected by a user, a created link can be protected from subsequent changes or deletion. Further, a duration of such protection can be limited, based upon an amount of a payment provided, or can be renewable, based upon a recurring payment (e.g., as in a subscription with a periodic renewal fee).

A link is typically defined as including both the URL and a user-designated combination of keywords. However, because keyword-based navigation and resource-designation largely depends upon a particular keyword combination corresponding to a particular network resource, reference herein to an “already stored link” generally means an already linked combination of keywords. Therefore, protecting a link from being changed or deleted generally means either of preventing the one or more keywords linked to a network resource from being used to designate another network resource, or preventing a dissociation of those user-designated keywords from the network resource designated by the user at the time the link was created.

In an exemplary embodiment, a data record includes one or more columns for entry, corresponding to each link entry, of either or both of an indication that a user-submitted payment is associated with the link, and an indication of a link termination condition. For example, an additional column provided in a data record may be designated for entry of a payment indication. In a typical embodiment, at a location in the payment column corresponding to a row where a particular link is stored, a payment submitted by a user can be indicated simply by a payment status of “Yes.” Conversely, the absence of a user-submitted payment may be indicated by a payment status of “No,” or by a null entry (e.g., by leaving blank). Alternatively, an amount of a payment can be entered in the payment column corresponding to a recorded link, such as when users are provided with an option to choose between different payment amounts, and each amount corresponds to a different link duration.

In an embodiment, upon selecting the link creation actuator 210 to create a designated link, the coded instructions of an exemplary system cause associated data processing circuitry to present to the user, via the GUI, an option to submit a payment. The presented option may indicate one or more payment amount options, and may also indicate a duration of time associated with the one or more payment options. However, the coded instruction may alternatively be configured to present such payment options to the user only after the user makes a selection indicating that they wish to submit a payment.

The coded instructions are further configured in an exemplary embodiment, in response to the user submitting a payment, to cause the data processing circuitry to store at the data record an indication that a payment was submitted by the user. The indication will typically be stored in the same row of the data record as the URL and the one or more keywords of the link, but in a column designated for such payment indications. Additionally, in instances where either the payment itself or an amount of the payment corresponds to a predetermined link retention duration, an indication of the link retention duration associated with the payment may likewise be stored in the data record entry corresponding to the link, but in a column of the data record designated for storing indications of a link duration termination condition. In the exemplary embodiments, expiration of a predetermined link retention duration is an example of a link terminating condition.

Exemplary pseudocode for querying whether a user wishes to submit a payment corresponding to a combination of keywords that is not already stored in a data record may be represented as:

If the combination has not been used

Ask user if they want to pay so no one can change the link
If they pay

Payment status is yes
Insert keywords, URL, date created, and payment status into
table

Else

Payment status is no
Insert keywords, URL, date created, and payment status into
table

Likewise, if the combination of keywords has been used in an already existing link stored in the data record, the coded instructions are configured to cause the data processing circuitry to determine if the data record includes an indication that the stored link is protected against change (e.g., the combination of keywords is reserved) by a payment. If not, then the existing link is deleted, the newly requested link is stored, and the user is queried regarding a desire to submit a payment to protect the link from subsequent changes or deletion. Exemplary pseudocode for these alternative actions may be represented as:

If the combination has been used and payment status is no:

Delete old entry in the table
Ask user if they want to pay so no one can change the link
If they pay

Payment status is yes
Insert keywords, URL, date created, and payment status into
table

Else

Payment status is no
Insert keywords, URL, date created, and payment status into
table

If a user submits a payment, then an indication of the payment in the data record acts as an indication that the stored link cannot be changed, at least within the duration of time corresponding to the payment, or until another indicated link terminating condition is satisfied. When the indicated predetermined time period expires, then a link terminating condition is satisfied, and the link may thereafter be changed unless the user once again submits a payment to continue the unchangeable status of the link for at least another period of time corresponding to the payment. Exemplary pseudocode for these alternative actions may be represented as:

If the combination has been used and payment status is yes and the date
created is more than 30 days ago

Ask user if they want to pay so no one can change the link
If they pay

Payment status is yes
Insert keywords, URL, date created, and payment status into
table

Else

Payment status is no
Insert keywords, URL, date created, and payment status into
table

However, if a link termination condition is not yet satisfied, then the system will either notify the user that a new link using the designated combination of words cannot be created, such as by returning an error message when the user submits the link creation request to the system via the link creation actuator. For example, exemplary pseudocode for such activity and result may be represented as:

If the combination has been used and payment status is yes and the date
created is less than 30 days ago:

Print error message
End code

In the above examples, the coded instructions cause the data processing circuitry to access in a data record an indication of the date that an already stored link was created, and to then calculate a date that is thirty days after the link creation date. The thirty days operand in the equation is a predefined period of time, and the contemplated embodiments include any and all periods of time however long or short, without limitation. The result of that calculation, a specific date, temporally defines a termination condition of the stored link, and the temporal extent to which the user that saved the already existing link reserved the use of the specified combination of keywords.

The coded instructions further cause the data processing circuitry to compare the date resulting from that calculation to the current date, and to determine if the current date is within or outside the predetermined term for which the keyword combination was reserved. Stated another way, the circuitry determines whether the end of the reservation period has arrived, therefore satisfying a link termination condition.

In at least one embodiment, an indication that a link is unchangeable and not subject to deletion can be stored in a data record corresponding to a link even if no payment is submitted, such as when (1) the user possesses authorization for such (e.g., the user is a system administrator, the user possesses an authorization code, etc.), or (2) the user has been issued a credit for such, (3) during suspension of a requirement for payment to render links unchangeable, or in other situations not specifically listed here.

### Link Creation and Access Processes

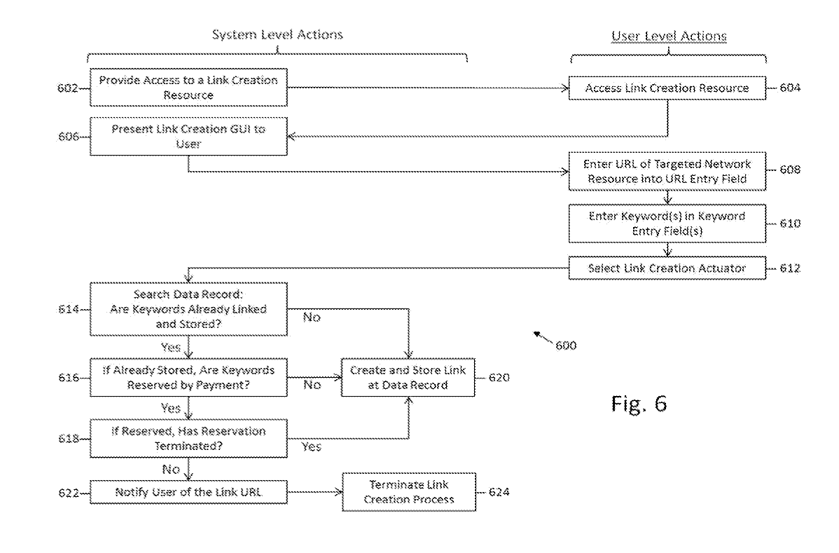

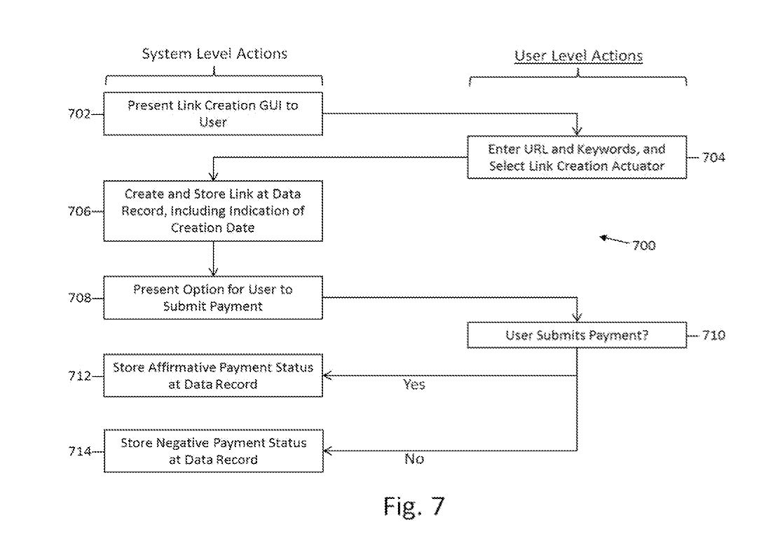

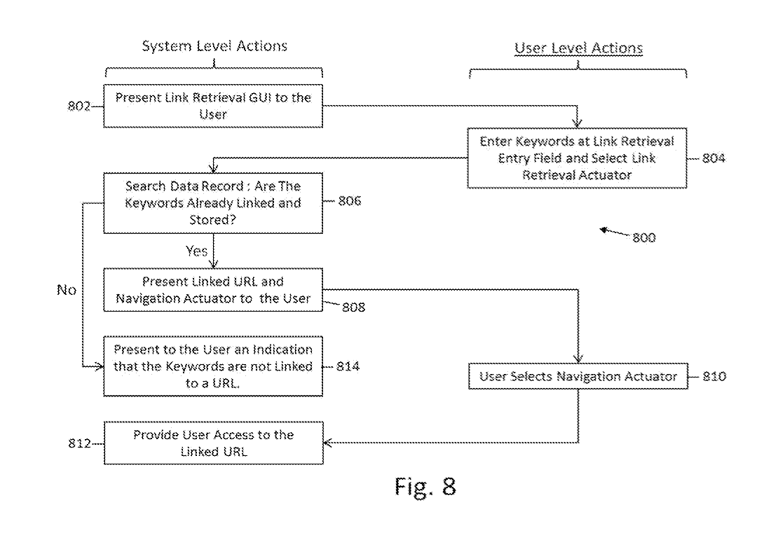

FIG. 6 depicts numerous operations of an exemplary link creation process 600. Reference herein to “the system” generally means both the coded instructions and associated data processing hardware enabling or causing various actions through execution of the instruction by data processing circuitry of a computing device (e.g., a server device, a user's computing device, etc.) in an embodiment of the invention. An ordinarily skilled artisan will recognize that the arrow leading from the label “600” is intended to indicate the depicted process as a whole, and not any particular depicted operation individually. The same is true, respectively, for the labels “700” and “800” in FIGS. 7 and 8.

For illustrative and descriptive clarity only, the operations depicted in FIG. 6, as well as FIGS. 7-8, are segregated according to whether they indicate an operation by or at the system level (e.g., at a server), or by or at the user level (e.g., input by the user at the user's device). An ordinarily skilled artisan will readily recognize, in view of this description, that the user's actions involve interface with a GUI that is served to the user's device from the server, according to the invented coded instructions.

At 602, access is provided to a link creation resource, such as an internet web page or a similar network resource, at or by which a user can create a link between a network resource address (e.g., URL) and one or more user selected keywords. Providing access generally means storing the operable coded instructions at a location or device that is accessible by users on the network. Likewise, a location, such as a network address (e.g., URL) at which users can access the instructions and cause their execution may likewise be published or otherwise provided to one or more users as a part of providing access to the link creation resource.

A user accesses the link creation resource at 604, and at 606 a link creation GUI 200 is presented to the user at a display device operably coupled with the user's computing device. The user enters a URL of a targeted network resource into the URL entry field of the GUI, at 608, enters one or more keywords into the one or more keyword entry fields of the GUI, at 610, and selects a link creation actuator (e.g., icon, etc.) of the GUI at 612.

Upon receiving the information submitted at the GUI by the user, the coded instructions cause data processing circuitry of the server device, at 614, to access and search a link data record, and to determine whether the keyword(s) selected by the user are already linked to a URL and stored in the data record. If the selected keyword(s) are not found in the data record, then the system creates a link therebetween by storing the keyword(s) and the URL in corresponding portions of a designated link data record (e.g., in adjacent or otherwise specifically identified cells of a database or data table) at 620.

However, if the user-selected keywords are found to exist in a link already stored in the data record, the system determines whether the data record includes an indication that the link is unchangeable, such as an indication that the keyword(s) have been reserved by a payment, at 616. If the keyword(s) are not reserved by a payment, then the system deletes the already existing unreserved link, and creates a new link and stores the user-selected keyword(s) and URL at the data record, as at 620.

If, however, the data record does indicate that the already existing link is unchangeable because the keyword(s) are reserved by payment, for example, the system attempts to determine, at 618, whether the reservation has terminated, such as by the expiration of a pre-determined period of time since creation of the link, or by the occurrence or non-occurrence of another event or condition. For example, the non-occurrence of an event can include the non-payment of a periodic link renewal charge. Upon such non-occurrence, the link would become changeable although having previously been non-changeable.

Conversely, the occurrence of an event that would cause a link to be indicated as changeable could include the cancellation of a link by a user. In embodiments, link payments constitute a reservation of a particular keyword or keyword combination, such as a rent, lease, subscription, or other similar arrangement. In such cases, a payment reserves a link for a pre-determined period of time, which may be agreed upon between a link service creation service provider and a user, or may be determined according to a schedule of reservation durations and corresponding fees, or may be standard and uniform in all situations. Such specifics are variable and selectable in alternative embodiments, and will be enabled and executed in the system by coded instructions configured for such purposes.

If the system determines at 618 that the data record indicates that the reservation has terminated or is otherwise changeable, the system creates a new link and stores the user-selected keyword(s) and URL at the data record, at 620. If, however, the data record indicates that the link remains unchangeable, the system notifies the user at 622, and terminates the link creation process at 624. The notification to the user can include any one of or combination of (1) causing the user's device to display an error message, (2) instructing the user that the keyword(s) are reserved, (3) informing the user of the URL linked to the keyword(s), (4) sending the user back to a link creation GUI so that the user can select a different keyword or combination of keywords to link to the URL, (5) an indication of a remaining duration before the keywords will no longer be reserved, or (6) some other indication that the system will not create the user's requested link.

As implied by the link reservation description above, FIG. 7 depicts an exemplary link creation process 700 wherein a user can reserve a link by submitting a payment. As in FIG. 6, the system presents a link creation GUI to a user, at 702, and then at 704, the user enters a URL and one or more keywords in the indicated entry fields, and then selects a link creation icon or other implemented embodiment of an actuator. The system, upon determining that no conditions exist that prevent creation of the requested link (as described above), creates and stores the link—including the selected keyword(s) and URL—at the data record, as shown at 706. Additionally, also at 706, the system associates with the link and also stores at the data record, data indicating the date that the link was created.

The system further presents to the user, at 708, an option for the user to submit a payment, for example to reserve the link for a predetermined period of time. If the user submits a payment, at 710, the system stores an affirmative payment status at the data record, as shown at 712. An affirmative payment status, which may be represented as “Yes” or by any other indication (e.g., “X,” an amount of the payment, a payment date, a reservation expiration date, or any other indication which the coded instructions may be configured in an embodiment to recognize as an affirmative payment status), may serve as an indication that the link is either temporarily or permanently unchangeable.

However, if the user does not submit a payment at 710, the system can then store a negative payment status at the data record, at 714. In a typical embodiment, a negative payment status serves as an indication that the created link is changeable. However, in one embodiment, the non-entry of a payment status at the data record acts as a negative payment status indication in contrast to the entry of an affirmative payment status indication, while in an alternative embodiment the non-entry of a payment status at the data record acts as an affirmative payment status indication in contrast to the entry of a negative payment status indication.

Further depicted in FIG. 8 is an embodiment of a link creation process in which a user requests to create a link, but the user-designated keywords are already linked to a URL. As described above regarding FIGS. 6 and 7, the system presents a link creation GUI to a user, at 802, and then at 804, the user enters a URL and one or more keywords in the indicated entry fields, and then selects a link creation icon or other implemented embodiment of an actuator. And as at 614 in FIG. 6, the system searches a link data record and determines whether the keyword(s) selected by the user are already linked to a URL and stored in the data record.

If the keyword(s) are already stored as part of a link, the system presents a GUI to the user, at 808, wherein the GUI indicates to the user the URL that is already linked to the designated keyword(s). The GUI likewise can present to the user a navigation actuator, which can be similar to a link creation actuator, such as an icon or other representation of executable coded instructions, except that the coded instructions associated with and executed following selection of the navigation actuator by a user, are distinct from those of a link creation actuator.

If, at 810, the user selects the navigation actuator, the associated coded instructions execute, and the user is provided with access to the linked URL, as at 812. In a typical embodiment, providing access means that the system accesses the linked URL and serves it up to the user's computing device via a network “browser” application operating on the user's computing device or otherwise operably coupled with the user's computing device.

If at 806, however, the system determines that the user-designated keyword(s) are not already linked to a URL and stored at a link data record, the system presents to the user, at 814, and indication that the keyword(s) are not already linked to a URL, and the link creation process may continue as described above regarding FIG. 7, for example.

### Advantages Provided by the Invented Embodiments

As would be readily recognized by an ordinarily skilled artisan in view of this description, the invented embodiments provide substantial benefits not currently achieved or available to users of computing networks. Such benefits include but are not limited to the following, each according to at least one embodiment of the invention:

Provides a simple GUI configured to instruct a user regarding actions to take to submit a request to create a link between one or more user-designated keywords and a network resource address.

Enables users to designate intuitive, easily-remembered keywords or combinations of keywords as substitutes for complex, lengthy, non-intuitive network addresses. Therefore, users can more easily remember links to network resources, and can more easily and succinctly communicate such links to others.

Enables multiple users to each specify their own keyword or combination of keywords and to each create a link to the same URL. Therefore, multiple users can each access the same URL based, literally, on their own terms.

Stores created links in a centralized location for later retrieval and use by the link creator or other users for accessing the linked network resource address.

Provides a network-accessible resource (e.g., web site) configured with tools (e.g., operable coded instructions—as software, firmware, etc.) which enable a user to link user-designated keywords to a user-specified network resource address.

Prevents an already-linked and stored keyword or keyword combination from being concurrently linked to more than one network resource address.

Provides a uniform, user-designated keyword or keyword combination that, unlike a bookmark saved in a browser on a computing device, is nearly infinitely portable and device independent; the keyword(s) can be used by the user or by another user to access a designated and linked URL from nearly any computing device or other device that can operably access the network.

Enables a provider of the services to assign a duration of time or another operable link terminating condition, to store an indication of such condition associated with the created and stored link, such that the link is terminated when associated data processing circuitry determines that the condition is satisfied.

Enables a user to reserve a keyword or keyword combination, as linked to a particular network resource address, by submitting a payment or another form of consideration, or by simply indicating an intent that a link terminating condition should not be associated with the link.

Enables a user to renew a reservation of an already-created and stored link, such as by submitting a renewal payment or another form of consideration, or by simply indicating an intent that the link should not terminate.

Informs a user via a GUI if a requested keyword or keyword combination is reserved for use in an already-created and stored link to a URL.

Provides a simple GUI configured to allow a user to enter one or more keywords, to access a link corresponding to the entered keyword(s), and to navigate to a network resource address that is linked to the entered keyword(s).

Provides a network resource at which any user can enter a specific keyword or keyword combination, and unlike a search engine, will, in an embodiment, receive one and only one search result that is specifically indicated by the entered keyword(s), enabling highly specific network navigation.

By the use of plain text words as keywords, enables a spelling-checking application present on a user's computing device or on a network system within which the user operates to detect when a keyword may have been improperly entered by a user.

Allows a commercial user to register a URL that is entirely non-representative of the user's products, services, or corporate identity, yet create one or more operable links to that URL utilizing keywords that are clearly and directly representative of that user's products, services, or corporate identity. Therefore, the user may be able to obtain a less expensive URL registration, or can avoid registering a URL that may be confusingly similar to that of another registrant. Likewise, the commercial user can avoid having to purchase a more representative URL from a speculator who earlier reserved the URL with the intent to sell it to the commercial user or another.

Allows commercial users to create operable links to their network resources, where such links are designated by a keyword or combination of keywords that are relevant to their products, services, promotions, trademarks, corporate identity or other information that is associated with the commercial user. For example, a retailer named “XYZCo” could use the keyword combination “XYZCo Black Friday,” to link customers to a web page that lists products or services discounted for the “Black Friday” sale. Further, such links can be either permanent, automatically terminable, or user-terminable. For example, XYZCo could specify that the above described link will last for only as long as the duration of the sale, after which the link associated with the keywords “XYZCo Black Friday” automatically terminates.

The invention is not limited to the coded instructions being prepared according to any specific programming language (e.g., C++, VISUAL BASIC, proprietary programming languages, etc.), or being executed on any particular computing platform (e.g., MICROSOFT WINDOWS, APPLE OS, LINUX, proprietary operating systems, etc.). Rather, as would be understood by an ordinarily skilled artisan in view of this description, operable embodiments of the invention can be prepared using any of numerous programming languages, for use on any of numerous different computing platforms.

Additionally, in light of the proliferation of mobile devices configured to access resources via an operable connection to one or more communication or data-transfer networks, the contemplated embodiments include at least one configured as a mobile device application, or “app,” downloadable from a network resource (e.g., APPLE ITUNES, etc.) and executable on one or more mobile devices.

Further, contemplating the particular benefit of the invented embodiments to those having a physical attribute or condition that would otherwise hinders facile use of and interaction with a computing device, the contemplated scope of the invention likewise includes at least one embodiment configured to receive commands, data input, or selection of a control (e.g., an actuation icon, etc.) via voice input (e.g., by use of integrated or stand-alone voice recognition software and an audio input device, such as a microphone, configured to convert an analog audio signal to digital data, etc.), an eye-tracking system (e.g., apparatus and associated software application), a sip and puff device, or another such assistive technology, means or methods currently known or used in the art.

An example of an existing voice interface application is the DRAGON NATURALLYSPEAKING software available from Nuance Communications, Inc. of Burlington, Mass. An example of an existing eye gaze interface application is the EYEGAZE EDGE software available from LC Technologies, Inc. of Fairfax, Va. An example of an existing sip and puff interface device and related controls is the SIP/PUFF SWITCH from Origin Instruments of Grand Prairie, Tex. These limited examples illustrate not only numerous other available, similarly functioning devices and applications, but also of numerous other devices and applications useful to assist users relative to other types of physical conditions, such as impaired vision, neuromuscular impairment, etc.

In at least one embodiment, the invention can include or otherwise utilize associated language translation software to receive input from or convey information to a user in an alternate language, thus helping to reduce language barriers form impeding the benefits available from the invented embodiments. One example of such language translation software is GOOGLE TRANSLATE from Google of Mountain View, Calif.

Likewise, at least one embodiment of the invention includes coded instructions configured to cause a device to emit user-audible simulated vocalizations either to augment or as an alternative to presenting information to the user visually upon a display of the device. In such cases, the device should include an audio transducer (e.g., speaker) configured to convert digitized data to an user-audible analog audio signal.

Of course, voice input and voice control are well-known with regard to mobile and other computing devices, for example, so such embodiments are not intended for use only by users having physical limitations, but rather are intended for use by any user that prefers to interact with a device by voice interface.

Throughout this description, the terms ‘may’, ‘can’, ‘should’, and others are used (e.g., ‘may be’, ‘may include’, ‘may comprise’, etc.) to indicate that while details of an element are present in one embodiment, other embodiments may differ in the details of one or more elements. Therefore, these terms are used herein in a definite sense relative to at least one embodiment, but not all embodiments, and will not be considered indefinite by one having skill in the art.

The invented method, and the system that enables it, are described by the use of examples and illustrations herein. However, the contemplated full scope of the invention is not limited to only the specifically presented exemplary embodiments, as will be recognized by an ordinarily skilled artisan in light of this specification and the accompanying drawing figures and claims. Indeed, any suitable variation, equivalent or application is contemplated as an alternative embodiment, and thus is within the spirit and scope, of the invention, whether or not specifically stated within the detailed written description or illustrations contained herein.

Those having skill in the art will further appreciate that the invented embodiments described and illustrated herein may be implemented in software, firmware or hardware, or any suitable combination thereof. Thus, those of skill in the art will appreciate that embodiments of the invention may be implemented by a computer or microprocessor process in which instructions are executed, the instructions being stored for execution on a non-transitory computer-readable medium and being executed by any suitable instruction processor.

Accordingly, while the present invention has been shown and described with reference to the foregoing embodiments of the invented apparatus, it will be apparent to those skilled in the art that other changes in form and detail may be made therein without departing from the spirit and scope of the invention as defined in the appended claims. All trademarks included in this specification are the property of their respective owners, and applicant does not claim any rights in such marks by their inclusion herein.

I claim:

1. A network resource address substitution system, comprising:
machine-readable coded instructions stored on a non-transitory data storage medium, the instructions being configured, when executed by data processing circuitry of a network-linked computing device, to cause the computing device to:
render a link creation graphic user interface (GUI) viewable to a user at an operably-coupled display device, wherein the GUI includes:
a network resource address entry field configured to accept entry, by the user, of an address of an existing network resource;
one or more ordered keyword entry fields, each keyword field configured to accept entry, by the user, of a user-designated word;
a user-selectable link actuator configured, when selected by the user via an input device, to cause the data processing circuitry to execute coded instructions configured to create a network-accessible link between a network resource address entered at the network resource address entry field and one or more user-designated words entered at the one or more ordered keyword entry fields; and
store at a data record retained on a non-transitory data storage medium operably coupled with the computing device, a link entry including each of:
a network resource address entered by a user at the network resource address entry field, and
one or more user-designated words entered at the one or more ordered keyword entry fields.

2. The system of claim 1, wherein the one or more user-designated words entered at the one or more ordered keyword entry fields are three in number.

3. The system of claim 1, wherein the instructions are further configured, in response to selection of the link actuator by a user, to:
cause the computing device to search the data record; and
determine whether the data record already includes a stored link entry including the user-designated words.

4. The system of claim 3, wherein the instructions are further configured, in response to determining that the data record does not include a stored link entry including the user-designated words, to cause the computing device to present to the user, via the GUI, an option to submit a payment.

5. The system of claim 4, wherein the instructions are further configured, in response to the user submitting a payment, to cause the computing device to store in the data record an indication that the link entry created by the user shall not be changed by another user.

6. The system of claim 3, wherein the instructions are further configured, in response to determining that the data record includes a stored link entry including the user-designated words, to further determine whether the stored link entry includes an indication that the link cannot be changed.

7. The system of claim 6, wherein the indication that the stored link entry cannot be changed comprises one or more of:
an indication that the link entry is reserved by a payment; and
an indication that a link terminating condition is satisfied.

8. The system of claim 7, wherein the link terminating condition is one of an expiration or a non-expiration of a predetermined time period indicated in the instructions.

9. The system of claim 8, wherein the predetermined time period is calculated based upon a time at which the stored link entry was created.

10. The system of claim 6, wherein the instructions are further configured, in response to determining that the data record includes an indication that the link cannot be changed by the user, to cause the computing device to indicate to the user, via the GUI, that a link cannot be created between the network resource address entered by a user and the one or more user-designated words entered by the user.

11. The system of claim 6, wherein the instructions are further configured, in response to determining that the data record does not include an indication that the link cannot be changed by the user, to cause the computing device to store at the data record each of the network resource address entered by a user and the one or more user-designated words entered by the user.

12. The system of claim 1, wherein the instructions are further configured, when executed, to render a link retrieval GUI viewable to a user at a display device, wherein the link retrieval GUI includes:
a link retrieval entry field configured to accept entry, by a user, of one or more ordered words; and
a link retrieval actuator configured, when selected by the user via an input device, to cause the network-linked server device to compare the one or more ordered words entered at the link retrieval entry field with one or more sets of user-designated words previously linked to one or more network resource addresses and stored at the data record, and to determine if the one or more ordered words entered at the link retrieval entry field match a set of linked, stored, ordered, user-designated words.

13. The system of claim 12, wherein the instructions are further configured, upon determining that the one or more ordered words entered at the link retrieval entry field match a previously linked and stored set of one or more user-designated words, to present at a GUI either or both of:
the network resource address that is linked to the matched set of user-designated words; and
a user-selectable navigation actuator configured, when selected by the user, to cause the computing device to access the network resource designated by the network resource address that is linked to the matched set of user-designated words.

14. The system of claim 13, wherein a match is determined when the one or more ordered words are entered at the link retrieval entry field in the same sequence as the one or more user-designated words linked to a network resource address.

15. A network resource address substitution method, comprising:
configuring a network resource address substitution system with machine-readable coded instructions stored on a non-transitory data storage medium, the instructions being configured, when executed by data processing circuitry of a network-linked computing device, to:
cause the computing device to render a link creation graphic user interface (GUI) viewable to a user at a display device, wherein the GUI includes:
a network resource address entry field configured to accept entry, by the user, of an address of an existing network resource;
one or more ordered keyword entry fields, each keyword field configured to accept entry, by the user, of a user-designated word;
a user-selectable link actuator configured, when selected by the user via an input device, to cause the data processing circuitry to execute coded instructions configured to create a network-accessible link between a network resource address entered at the network resource address entry field and one or more user-designated words entered at the one or more ordered keyword entry fields; and
store, at a data record retained on a non-transitory data storage medium operably coupled with the computing device, a link entry including each of:
a network resource address entered by a user at the network resource address entry field, and
one or more user-designated words entered at the one or more ordered keyword entry fields; and
rendering the network resource address substitution system accessible to a user via a data transfer network.

16. The method of claim 15, wherein the one or more user-designated words entered at the one or more ordered keyword entry fields are three in number.

17. The method of claim 15, wherein the instructions are further configured, in response to selection of the link actuator by a user, to:
cause the computing device to search the data record; and
determine whether the data record already includes a stored link entry including the user-designated words.

18. The method of claim 17, wherein the instructions are further configured, in response to determining that the data record does not include a stored link entry including the user-designated words, to cause the computing device to present to the user, via the GUI, an option to submit a payment.

19. The method of claim 18, wherein the instructions are further configured, in response to the user submitting a payment, to cause the computing device to store in the data record an indication that the link entry created by the user shall not be changed by another user.

20. The method of claim 17, wherein the instructions are further configured, in response to determining that the data record includes a stored link entry including the user-designated words, to further determine whether the stored link entry includes an indication that the link cannot be changed.

21. The method of claim 20, wherein the indication that the stored link entry cannot be changed comprises either or both of:
an indication that the link entry is reserved by a payment; and
an indication that a reservation terminating condition is satisfied.

22. The method of claim 21, wherein the reservation terminating condition is one of an expiration or a non-expiration of a predetermined time period indicated in the instructions.

23. The method of claim 17, wherein the predetermined time period is calculated based upon the time at which the stored link entry was created.

24. The method of claim 20, wherein the instructions are further configured, in response to determining that the data record includes an indication that the link cannot be changed by the user, to cause the computing device to indicate to the user, via the GUI, that a link cannot be created between the network resource address entered by a user and the one or more user-designated words entered by the user.

25. The method of claim 20, wherein the instructions are further configured, in response to determining that the data record does not include an indication that the link cannot be changed by the user, to cause the computing device to store at the data record each of the network resource addresses entered by a user and the one or more user-designated words entered by the user.

26. The method of claim 15, further comprising:
providing instructions configured, when executed, to render a link retrieval GUI viewable to a user at a display device, wherein the link retrieval GUI includes:
a link retrieval entry field configured to accept entry, by a user, of one or more ordered words; and
a link retrieval actuator configured, when selected by the user via an input device, to cause the network-linked server device to compare the one or more ordered words entered at the link retrieval entry field with one or more sets of user-designated words previously linked to one or more network resource addresses and stored at the data record, and to determine if the one or more ordered words entered at the link retrieval entry field match a set of linked stored user-designated words.

27. The method of claim 26, wherein the instructions are further configured, upon determining that the one or more ordered words entered at the link retrieval entry field match a previously linked and stored set of one or more user-designated words, to present at a GUI either or both of:
the network resource address that is linked to the matched set of user-designated words; and
a user-selectable navigation actuator configured, when selected by the user, to cause the computing device to access the network resource designated by the network resource address that is linked to the matched set of user-designated words.

28. The method of claim 27, wherein a match is determined when the one or more ordered words are entered at the link retrieval entry field in the same sequence as the one or more user-designated words linked to a network resource address.
